(19) United States
(12) Patent Application Publication
(10) Pub. No.: US 2017/0169650 A1
(43) Pub. Date: Jun. 15, 2017

(54) Game With Side Display Areas For Providing Game Information

(71) Applicants: DEQ Systems Corp., Levis (CA); The Talisman Group, LLC, Las Vegas, NV (US)

(72) Inventors: Robin Clive Powell, Las Vegas, NV (US); David Jacques, Quebec (CA)

(21) Appl. No.: 15/279,229

(22) Filed: Sep. 28, 2016

Related U.S. Application Data
(60) Provisional application No. 62/233,997, filed on Sep. 28, 2015.

(51) Int. Cl. G07F 17/32

(52) U.S. Cl. CPC G07F 17/323; G07F 17/3288; G07F 17/3293; G07F 17/3246; G07F 17/3248; G07F 17/3211; G07F 17/3209; A63F 2001/001

(57) ABSTRACT

A method gaming at a gaming machine, at a gaming table, or at any other wagering device or system is disclosed that includes displaying one or more side areas which provide other player's wager information on the side area of the display and receiving a player wager. The player wager being a banker hand wager, and a tie wager. This method of operation deals and displays playing cards to a player on the gaming machine display to create a player card set and a banker card set. A player hand rank and a banker hand rank is calculated and evaluated to determine a game outcome. The game outcome being a player hand higher than banker hand, banker hand higher than player hand, or a tie and then providing an award to the player if the player wager matches the game outcome.

### 1. PRIORITY CLAIM

This application claims priority to and the benefit of U.S. Provisional Patent Application No. 62/233,997 filed on Sep. 28, 2015, the contents of which are incorporated by reference in its entirety herein.

### 2. FIELD OF THE INVENTION

The invention relates to a wagering game and in particular to a method and apparatus for displaying game play and additional game information the screen.

### 3. RELATED ART

Baccarat is a popular game that is enjoyed my numerous players and is often offered as a wagering game, such as in casino environments. It is often offered at a gaming table and played with a shoe of one or more decks of physical cards, or it can be simulated as an electronic table game or an online game.

The most commonly known form of baccarat is traditional baccarat, also known as punto banco, North American Baccarat, tableau Baccarat or mini-Baccarat, which are games of chance. Other forms of baccarat are baccarat chemin de fer and baccarat banque, which involve player skill in addition to an element of chance. The wagering outcomes in traditional baccarat are typically those of the “Player” hand winning, the “Banker” hand winning or neither of the said hands winning, thereby resulting in a so-called “Tie”, wherein tie bets win.

Although baccarat is a widely played and popular game, players are often seeking new game variations and new ways to win and interface with the game. In past displays of the game, the player may be represented with a view of the entire table, but this display method had the drawback that the primary player's position is confused with the other player positions at the table. In addition, with a view of the entire table, each player position presentation is small. This may prevent players from adequately monitoring not only their own hand and betting history, but also other player's betting activity. These drawbacks decrease player participation and excitement.

### SUMMARY

To overcome the drawbacks of the prior art and provide additional benefits, a method of playing a game at a gaming machine is disclosed. In one exemplary method of play using machine-implemented steps, a gaming machine is provided that includes a housing, a gaming machine display, a player interface, a bill or ticket acceptor, a memory storing non-transitory machine-readable code, and a processor configured to execute the machine readable code to perform one or more game steps such as the following. Displaying on the gaming machine display one or more side areas which provide other player's wager information in or on the side areas. Receiving a player wager with a bill or ticket acceptor that is part of the gaming machine, the player wager having an amount and placed on at least one of a player hand wager, a banker hand wager, and a tie wager. This method of play performed by the gaming machine then deals and displays playing cards to a player on the gaming machine display to create a player card set and a banker card set. The gaming machine calculates a player hand rank and a banker hand rank and evaluates the player hand rank and a banker hand rank to determine a game outcome such that the game outcome is one of the following: a player hand higher than banker hand, banker hand higher than player hand, or a tie. A monetary award is provided to the player if the player wager matches the game outcome.

This method of play may include updating the one or more side areas with the game outcome, which of the other player had winning wagers, or both. The one or more side areas may further display wager amounts by other players. The controller may be a processor configured to execute the machine readable code. In one embodiment, the one or more side areas further display a player name and wager amount. In another embodiment, the one or more side areas further display game outcomes for one or more prior games. It is also contemplated that the side areas are configurable by a player to display one or more of the following: amount wagered, specific player wager amounts, specific player bet history, past game outcomes.

Also disclosed is a gaming machine having a controller, at least one electronic display, at least one player input device on the gaming machine, and a monetary acceptor configured to receive a ticket or monetary value from a player to establish credits on the gaming machine, the credits wagerable via the player input device. Also part of the gaming machine is a ticket-in and ticket-out device configured to accept and print tickets such that the tickets represent monetary value which may be redeemed for credits at the gaming machine. A memory, that is part of the gaming machine, stores machine-readable code and the stored machine-readable code is executable by the controller to present a base game at the gaming machine. In this gaming machine embodiment the base game includes several steps. The gaming machine receives a player wager using credits. The credits are established on the gaming machine by a player using the monetary acceptor or the ticket-in and ticket-out device and the player wager has an amount and is placed on at least one of a player hand wager, a banker hand wager, and a tie wager. This method of operation displays, in one or more side areas of the electronic display, one or more other players' wager information for use by the player to determine which wager to make and how much to wager. This method deals and displays playing cards to a player on the gaming machine display to create a player card set and a banker card set. To continue the game, the method of play calculates a player hand rank and a banker hand rank, based on the cards displayed for each hand, and evaluates the player hand rank and a banker hand rank to determine a game outcome such that the game outcome is one of the following: a player hand higher than banker hand, a banker hand higher than player hand, or a tie. An award is provided to the player if the player wager matches the game outcome.

In one embodiment, the one or more side areas further display wager amounts by other players. It is contemplated that the controller is a processor configured to execute the machine readable code. The one or more side areas may further display a player name and wager amount, game outcomes for one or more prior games, or both. In one embodiment, the gaming machine further includes a computer network configured to transmit and receive game and wager information to other gaming machines. It is contemplated that the side areas may be configurable by a player to display one or more of the following: amount wagered, specific player wager amounts, specific player bet history, past game outcomes.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIGS. 1A through 1F illustrate exemplary screen displays including information areas located on the side of the screen.

FIG. 2A is a block diagram illustrating an example or representative computing devices and associated computer network.

FIG. 2B is a block diagram of an example embodiment of a mobile computing device.

FIG. 3 is a diagram illustrating an exemplary gaming machine.

FIG. 4 is a block diagram illustrating an example gaming system with a server based network.

FIG. 5 is a block diagram illustrating an example embodiment of a gaming table.

### DETAILED DESCRIPTION

The exemplary embodiments herein relate to wagering games such as Baccarat which is resolved at least in part by the randomly generated outcome of the game.

It should be understood that each of the methods and individual steps recited herein may be partially or wholly carried out in a variety of ways and/or systems, which may include, but are not limited to, a live dealer physically dealing playing cards in a casino, an electronic gaming machine (EGM) for use by one or more players, a multiplayer platform which may include a player interface such as a touchscreen display and involve physical or virtual playing cards, dealer and wagering chips, a home computer or portable computing device, such as a tablet computer or mobile phone capable of communicating with a network or over the Internet, global telecommunication network or world wide web. It should further be understood that the methods and systems of the invention are described herein in connection with a conventional Baccarat game for illustrative purposes only, as the methods and systems of the invention may be employed, combined or integrated with modified, variant or otherwise non-conventional Baccarat games, such as baccarat variants with modified rules, additional wagers or a modified vig, including no-commission or commission-free versions of baccarat like the game marketed worldwide by DEQ Systems, Corp. under the brand name EZ Baccarat™, as well as other games, such as Blackjack or Poker and variations thereof.

All references herein that are made to “cards”, “decks”, “dealing”, “hands” or other such expressions that are ordinarily used in describing a wagering game that is played with physical playing cards are also meant to describe and capture all associated electronic and online representations of said physical playing cards, including their associated graphical and numeric card symbols (for instance, suits such as hearts, spades, diamonds or clubs, face cards such as jacks, queens and kings, and the aces and other numbered cards of a typical playing deck). The said expressions are also meant to extend as well to all forms of electronic dealing, distribution or allocation of the said card symbols, according to the rules of the underlying wagering game.

Some of these game events may involve wagering and resolving a wager, or the generation and application of random data to predefined rules and determination of a final outcome in a first or underlying game. The generation of random data may be facilitated by computerized and/or physical implements. The transformative events may also include parsing of the data from the underlying game outcome for comparative purposes with preset criteria to determine an outcome in a second or associated wagering game.

Although the game of EZ Baccarat is known and popular, the following game rules provide additional disclosure. The object of the game is to achieve a hand with a point value of “9”. Players can bet (wager) on whether the player hand or banker (dealer) hand will be closer to or of a 9 value, or a tie. Included in some embodiments is a Dragon 7 bet, which can be considered an insurance bet. In one embodiment, this wager pays 40 to 1 when the three card winning banker hand totals 7 points. In some embodiments, players can also wager on the Panda 8 outcome, which pays 25 to 1 when a three card winning player hand totaling 8 points occurs.

During game play, player's hands are dealt to the PLAYER position and the BANKER position, and the value of each hand is determined by the sum of the combined cards: Ace has a value of “1”, numbers 2 through 9 have face value, the number 10, Jack, Queen, and King have a value of “0”. When combined cards have a total sum more than ten, the last digit of the total sum is deemed the value of the hand, i.e. 8+7=15=5. Hence, once a hand is completed, a scoring total will be determined according to the rules of traditional Baccarat, with a modulo 10 function being applied to the raw scoring sum obtained from the known card values of the respective hands in order to produce the single-digit scoring total of the foregoing table of outcomes. Thus, a card value of an ace is 1 while cards 2-9 are given face value. The ten card and face cards are assigned values of 10. The value of cards in a hand (either player hand or banker hand) are summed and the one digit in the resulting total forms the hand value.

A “Natural” is two cards with a point value of 8 or 9. A “Natural” is an automatic winner unless both PLAYER and BANKER have the same “Natural” value (tie). A “Natural” 9 would beat a “Natural” 8.

During game play, each participant in the game must place a wager on either “BANKER” or the “PLAYER” position. Participants may also make an optional wager on the “TIE”, “PANDA 8” or “DRAGON 7” position if the table is so equipped. Two hands of two cards each are dealt from the shoe. The two cards dealt on the House Dealer's right hand side is the PLAYER'S hand, and the two cards dealt on the House Dealer's left side is the BANKER'S hand. A third card may be required for either hand. Cards for both the Player and Dealer hands are dealt face up. Wagers are collected and determined prior to the start of each round of play based on the table limits of the game or other factors. The hand with the highest point value wins and the wage is paid, typically according to a pay table and based on the wager amount.

For the player hand, if the PLAYER and/or BANKER positions have an 8 or 9 on the first two cards, no further cards are drawn. However, a player must hit (take an additional card) on 0, 1, 2, 3, 4, 5 and stand on 6, 7, 8, and 9. In baccarat, there are no busted hands.

For the banker hand, a winning three card hand with a 7 point value will push instead of win. When the player hand does not draw a third card, the banker hand must hit on 0, 1, 2, 3, 4, 5 and must stand on 6, 7, 8, and 9

When the player hand and the banker hand result in the same value it is defined as a tie. Players may wager on a tie prior to the start of the game.

In one embodiment, the EZ Baccarat game eliminates the taking of the 5.00% commission after every banker winning hand without modifying any of the existing drawing rules of the standard game. Instead of taking the commission when the banker (dealer) wins with a total of seven consisting of three cards—the banker hand is a “push”, or “barred”. But, the Player hand and Tie bets lose, as normal. This simple modification builds the commission right into the dealing of the game. The EZ Baccarat game, rules, and method of play is generally known by one of ordinary skill in the art and as such it is not described in detail herein.

As discussed herein, there are optional side bets known as a Panda 8 and a Dragon 7. The Panda 8 is when the Player wins with a total of eight consisting of three cards. The Dragon 7 is when the Banker wins with a total of seven consisting of three cards.

The game as described herein may also be configured or offered as traditional baccarat in which the house or dealer takes a 5% commission on winning banker bets, or some other value or percentage of commission and the traditional baccarat rules are applied. Traditional baccarat is generally known by one of ordinary skill in the art and as such is not described in detail herein.

One or more various patents that describe baccarat with a commission, baccarat without a commission, or baccarat scoring with the display of historical results or are incorporated by reference in their entirety, including U.S. Pat. No. 5,979,896, U.S. Pat. No. 5,362,064, and U.S. Pat. No. 6,217,447 and it is contemplated that any of the features of these patents may be combined, alone or in combination with the game and display features disclosed herein.

The terms “gaming,” “gambling,” or the like, refer to activities, games, sessions, rounds, hands, rolls, operations, and other events related to wagering games, such as web-based games, casino games, card games, dice games, and other games, the outcome of which is at least partially based on one or more random events (“a game of chance”) and on which wagers may be placed by a player. In addition, the words “wager,” “bet,” “bid,” or the like refer to any type of wagers, bets, or gaming ventures that are placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that are “play for pay” as well as “play for fun,” as will be described in more detail below.

### Play for Fun

In some embodiments, wagering games may be played without risking money in connection with the wagers (i.e., “play-for-fun” games). Access to play-for-fun wagering games may be granted on a time period basis in some embodiments. For example, upon initially joining the wagering game, each player may automatically be given wagering elements, such as for example, chips, points, or simulated currency, that is of no redeemable value. After joining, the player may be free to place wagers using the wagering elements, and a timer may track how long the player has been participating in the wagering game. If the player exhausts his or her supply of the wagering elements before a predetermined period of time has expired, the player may simply wait until the period of time passes to rejoin the game and receive another quantity of the wagering elements to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait after exhausting their supply of wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may retain their remaining wagering elements for subsequent allotments of time and may receive additional wagering elements corresponding to the new allotment of time to further increase the balance of wagering elements at their disposal. Players may be assigned to different categories of players, which determine the number of wagering elements awarded. In a given period of time, higher-level players or players who have invested more time playing the game may earn more wagering elements per unit of time than a player assigned to a lower level group.

In some embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be purchased or may be obtained without directly exchanging money for the access tokens. For example, access tokens may be acquired by participating in member events (e.g., completing surveys, receiving training on how to play the wagering game, sharing information about the wagering game with others), spending time participating in the wagering game or in a player account forum (e.g., logged in to a social media account), or viewing advertising. Thus, an entity administering play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After a player has stopped participating in a play-for-fun wagering game, any remaining quantities of the wagering elements may be relinquished by the player, in some embodiments. For example, logging out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, the quantity of wagering elements held by a player when stopping participation may be retained and made available to the player, along with any additional quantities of wagering elements granted for new allotments of time, when rejoining the wagering game.

The wagering games supported by a gaming system may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, for time played in one session, or for games played; or simply being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The system may enable players to buy additional game credits to allow the player to resume play. Objects of value may be awarded to play-for-fun players, which objects of value may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

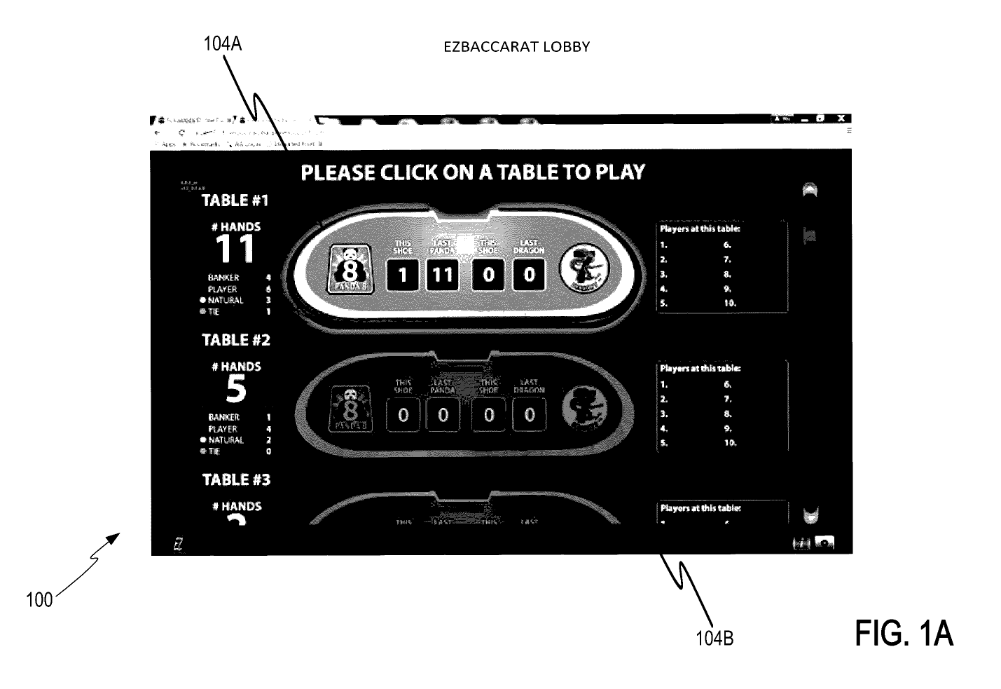

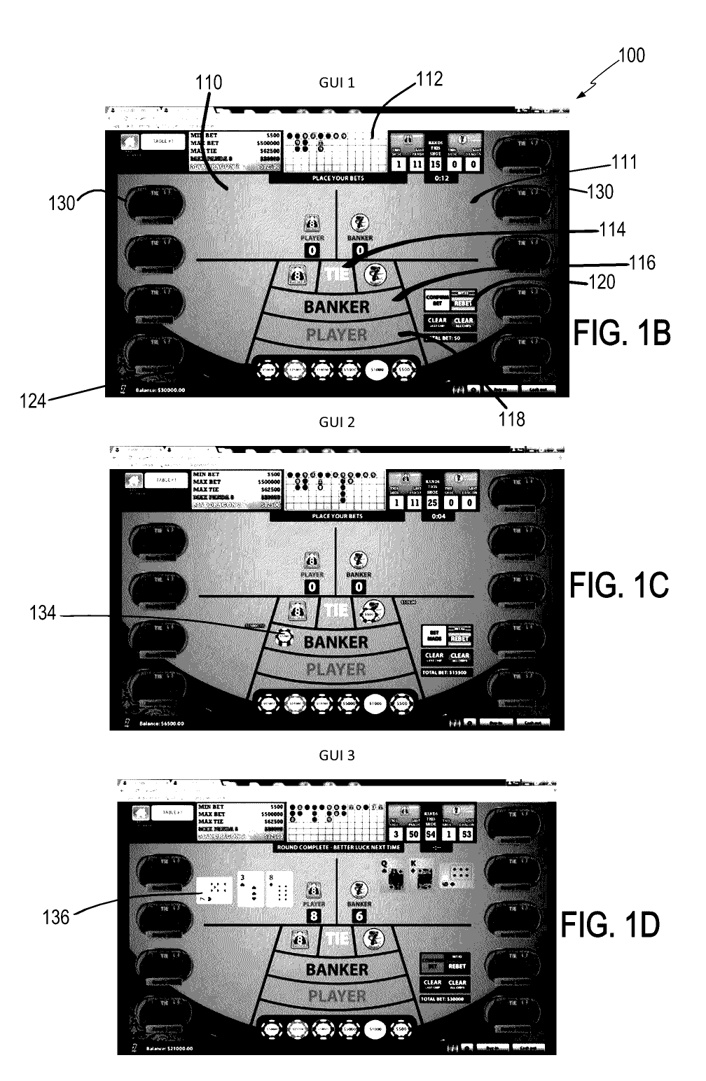

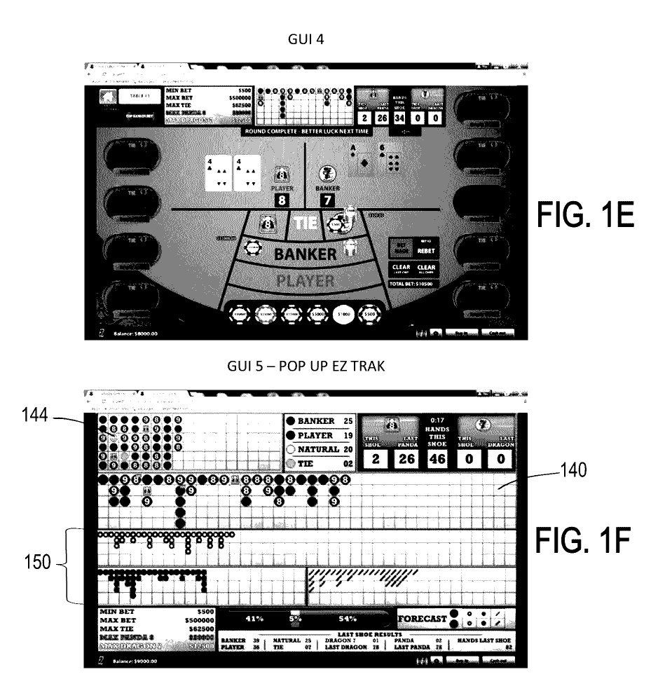

FIG. 1A illustrates an exemplary screen display for a player acceptance and game entry. As shown, this display 100 may be made to a player who is back betting at a gaming machine, or gaming terminal, mobile device, or a computer (e.g. playing on an Internet gambling website or an Internet play for fun website, or any private network). This display may be presented to a player so that that player may enter the game to being playing and wagering. On the display 100, one or more tables 104A and 104B are shown that a player may click on or otherwise select to join that table to play at that table. Within the screen area on the table is one or more game statistics such as but not limited to the number of players at the table, the number of hands dealt at the table, and any other relevant information. It is contemplated that the player will select, by clicking on a table, a game to enter by selecting a table at which they will play the game.

FIGS. 1B, 1C, 1D and 1E illustrate exemplary screen displays of a baccarat game with one or more side display areas to show additional game data. These figures are described together. As compared to the prior art, which displayed an entire table, the exemplary display shown in FIGS. 1B, 1C, 1D and 1E provides an expanded or enlarge display of the player's betting area, but still includes additional content and information on the display in the side areas in secondary wagering area. As shown, the player card area 110 and banker (dealer) card area 111 are locations on the display 100 where dealt cards 136 are displayed. Also shown are betting areas for a tie wager area 114, banker wager area 116, and player wager area 118. A player input section for receiving player input is provided as a multiple option input window 120. A wager selection area 124 is provided at the bottom of the screen to allow a player to click or touch a wager 134 to be made. Also shown is a game information area 112 in which numerous types of game information may be provided including historical results displayed in different ways. The display game information may be information regarding the current game data or past game data, or both. The game information may comprise player's past wager amounts, other player's past wager amount, which hand (player, banker, tie) a player's wagered on in the past, which hand (player, banker, tie) other player's wagered on in the past, wager amounts for current and/or prior hands for the player and/or other players, past game outcomes, past winning and losing patterns for other players, or any other data regarding any player or any current or past game.

The display 100 also includes side areas 130 which may be configured to display various current or prior game information, which may be fixed or selected by the player. While the main display wagering area 114, 116, 118 ideally enlarges the player's (player who is actively playing the game and at the display) bet and bet options, the player may desire to see other information. By placing this other game information in the side area, the player is able to not only clearly see and identify their own wagers, but also see additional information, namely any of the game information as described above.

The side areas may be configured to display the player's past wagers and associated win/loss information or the current or other player's past betting decision and wager amounts and game outcomes. Players may use this information to predict future outcomes. For example, the side areas 130 may be labeled with prior game identifiers and then display how the player bet and whether the player won or lost. Using this information, the player may determine or predict the outcome of future hands and whether their past predictions were correct or not. Using this information is beneficial to the player or the player perceives it as beneficial because it allows the player to play the game with more accuracy and additional game data, which is not efficiently available in the prior art.

The side areas may also be configured to display other player wagers, such as wagers on the gaming being played. By displaying other player's wagers in the side areas, the player's wagers are clearly shown and easily identifiable. Displaying it in the side area also allows the player to determine what other players are wagering on and then follow the betting patterns of one or more other players. For example, using this system, certain players may utilize a strategy of ‘follow the general’ in which they determine a player to follow who is their leader, or who they perceive to be lucky, or a knowledgeable gambler or gamer, or on a winning streak. The player may use the wager patterns of other players to select which wager they will make. By placing this information on the designated side area the player may easily identify their betting area while also having knowledge about other player's betting. In contrast to the prior art method of a table surface with all players shown on the table, the use of side areas allows more of the players wagering behavior to be shown on one screen and additional players to be displayed. Prior art embodiment does not enable such game play and information display.

The side areas may be configured to display game outcomes for past games for the game in general to allow the player, which still clearly seeing their own wagers and wager area, to predict present and future game outcomes based on the past game outcomes. For example, the side areas 130 may display the outcomes of past games, and may or may not include player(s) betting information. By providing the past game outcomes, namely did the banker (dealer) win, did the player win, or was the game a tie, the player can predict future outcomes.

It is further contemplated that the player may be presented with the option of toggling between different views or types of information displayed in the side areas to suit the players desired information needs or to selectively obtain information during the betting process. These options are shown in FIG. 1F. For example, the player may click or touch various areas of the screen or provide other player input to the gaming system to transition between different information display types as described herein in the side areas 130 to collect the information the player needs or wants to use to determine how to bet. The screens may show the data in tabular form 140 and may be color coded or displayed with different shapes 144 or codes to convey information. One or more additional areas 150 may be provided to display different types of data, such as any type of current or past game or player/other player data discussed herein.

These options and benefits of the player of the side 130 are made even more important in game such as but not limited to Baccarat which deal a limited number of cards, in this case no more than six cards. Because only six cards are dealt per hand, a greater number of players may participate in each game during use of a 52 card deck of playing card. As the number of players increase, such as nine to eleven players, the size of each player wagering area in prior art display (which show the entire table) is reduced to a size that is non-functional or would be confusing to the player and difficult to see. By moving each of the other players' wagering areas to the side areas 130, more information may be clearly displayed and game play is improved. Likewise, the speed of game play is increased, which results in a more active and exciting game play experience and increased revenue for the game operator.

In one embodiment the display area inside the side areas 130 looks the same as the player wager areas 114, 116, 118, or may be tabular or other graphic format to present the information to the player. It is also contemplated that the other player and past game information may be located on any other area of the display.

FIG. 1F illustrates an alternative display for providing game outcomes in prior games and player wagers with outcomes over time based on past games. This is one optional way of displaying such information to a player during or after game play to aid the player with gaming decisions.

It is contemplated that the wagering game may be offered over a network, such as a gaming network or computer network for play at one or more remote locations, or collectively at a single network.

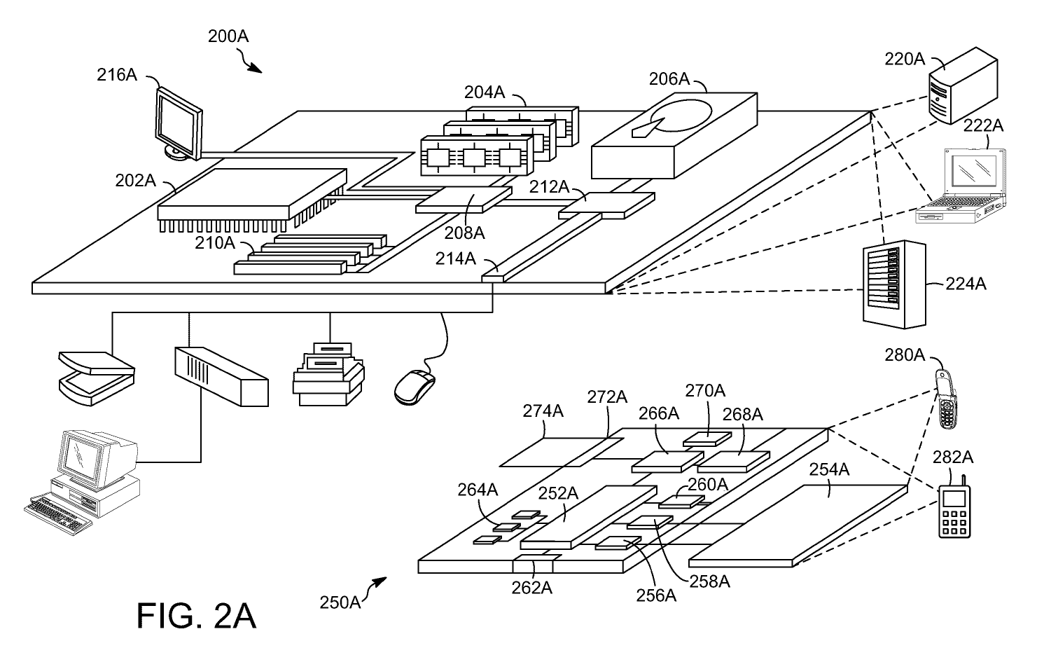

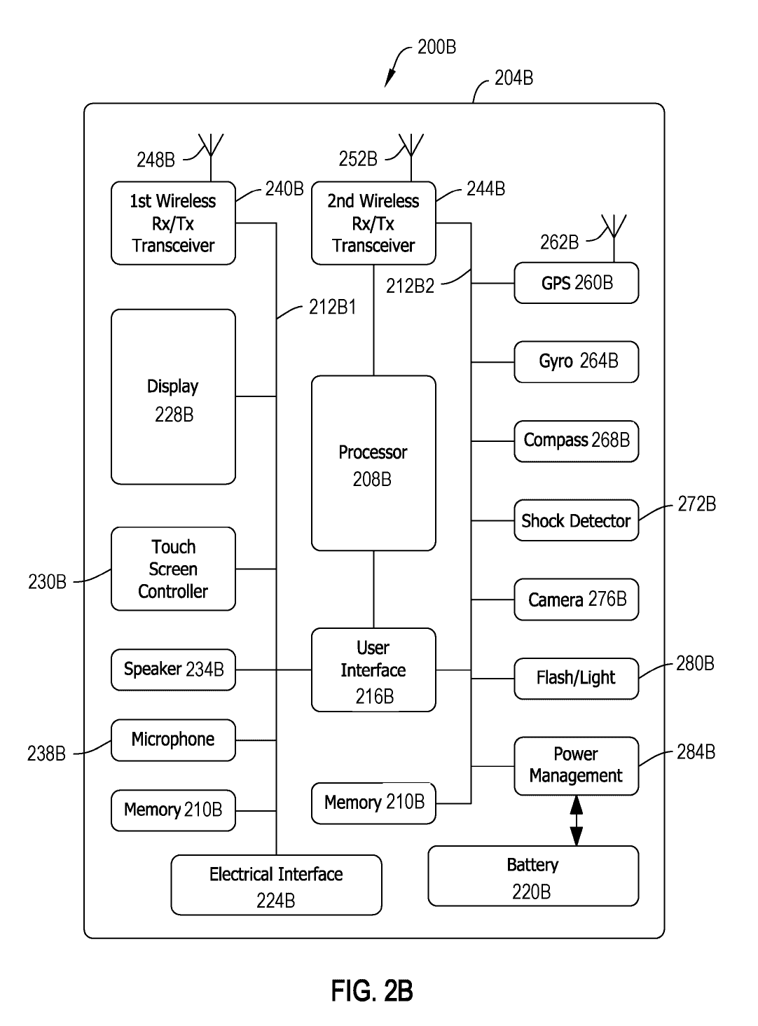

FIG. 2A is a block diagram showing example or representative computing devices and associated elements that may be used to implement the systems method and apparatus described herein. FIG. 2A shows an example of a generic computing device 200A and a generic mobile computing device 250A, which may be used with the techniques described here. Computing device 200A is intended to represent various forms of digital computers, such as laptops, desktops, workstations, personal digital assistants, servers, blade servers, mainframes, and other appropriate computers. Computing device 250A is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 200A includes a processor 202A, memory 204A, a storage device 206A, a high-speed interface or controller 208A connecting to memory 204A and high-speed expansion ports 210A, and a low-speed interface or controller 212 connecting to low-speed bus 214A and storage device 206A. Each of the components 202A, 204A, 206A, 208A, 210A, and 212A, are interconnected using various busses, and may be mounted on a common motherboard or in other manners as appropriate. The processor 202A can process instructions for execution within the computing device 200A, including instructions stored in the memory 204A or on the storage device 206A to display graphical information for a GUI on an external input/output device, such as display 216A coupled to high-speed controller 208A. In other implementations, multiple processors and/or multiple buses may be used, as appropriate, along with multiple memories and types of memory. Also, multiple computing devices 200A may be connected, with each device providing portions of the necessary operations (e.g., as a server bank, a group of blade servers, or a multi-processor system).

The memory 204A stores information within the computing device 200A. In one implementation, the memory 204A is a volatile memory unit or units. In another implementation, the memory 204A is a non-volatile memory unit or units. The memory 204A may also be another form of computer-readable medium, such as a magnetic or optical disk.

The storage device 206A is capable of providing mass storage for the computing device 200A. In one implementation, the storage device 206A may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204A, the storage device 206A, or memory on processor 202A.

The high-speed controller 208A manages bandwidth-intensive operations for the computing device 200A, while the low-speed controller 212A manages lower bandwidth-intensive operations. Such allocation of functions is exemplary only. In one implementation, the high-speed controller 208A is coupled to memory 204A, display 216A (e.g., through a graphics processor or accelerator), and to high-speed expansion ports 210A, which may accept various expansion cards (not shown). In the implementation, low-speed controller 212A is coupled to storage device 206A and low-speed bus 214A. The low-speed bus 214, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 200A may be implemented in a number of different forms, as shown in the figure. For example, it may be implemented as a standard server 220A, or multiple times in a group of such servers. It may also be implemented as part of a rack server system 224A. In addition, it may be implemented in a personal computer such as a laptop computer 222A. Alternatively, components from computing device 200A may be combined with other components in a mobile device (not shown), such as device 250A. Each of such devices may contain one or more of computing device 200A, 250A, and an entire system may be made up of multiple computing devices 200A, 250A communicating with each other.

Computing device 250A includes a processor 252A, memory 264A, an input/output device such as a display 254A, a communication interface 266A, and a transceiver 268A, among other components. The device 250A may also be provided with a storage device, such as a microdrive or other device, to provide additional storage. Each of the components 250A, 252A, 264A, 254A, 266A, and 268A, are interconnected using various buses, and several of the components may be mounted on a common motherboard or in other manners as appropriate.

The processor 252A can execute instructions within the computing device 250A, including instructions stored in the memory 264A. The processor may be implemented as a chipset of chips that include separate and multiple analog and digital processors. The processor may provide, for example, for coordination of the other components of the device 250A, such as control of user interfaces, applications run by device 250A, and wireless communication by device 250A.

Processor 252A may communicate with a user through control interface 258A and display interface 256A coupled to a display 254A. The display 254A may be, for example, a TFT LCD (Thin-Film-Transistor Liquid Crystal Display) or an OLED (Organic Light Emitting Diode) display, or other appropriate display technology. The display interface 256A may comprise appropriate circuitry for driving the display 254A to present graphical and other information to a user. The control interface 258A may receive commands from a user and convert them for submission to the processor 252A. In addition, an external interface 262A may be provided in communication with processor 252A, so as to enable near area communication of device 250A with other devices. External interface 262A may provide, for example, for wired communication in some implementations, or for wireless communication in other implementations, and multiple interfaces may also be used.

The memory 264A stores information within the computing device 250A. The memory 264A can be implemented as one or more of a computer-readable medium or media, a volatile memory unit or units, or a non-volatile memory unit or units. Expansion memory 274A may also be provided and connected to device 250A through expansion interface 272A, which may include, for example, a SIMM (Single In Line Memory Module) card interface. Such expansion memory 274A may provide extra storage space for device 250A, or may also store applications or other information for device 250A. Specifically, expansion memory 274A may include instructions to carry out or supplement the processes described above, and may include secure information also. Thus, for example, expansion memory 274A may be provides as a security module for device 250A, and may be programmed with instructions that permit secure use of device 250A. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 264A, expansion memory 274A, or memory on processor 252A, that may be received, for example, over transceiver 268A or external interface 262A.

Device 250A may communicate wirelessly through communication interface 266A, which may include digital signal processing circuitry where necessary. Communication interface 266A may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 268A. In addition, short-range communication may occur, such as using a Bluetooth, WI-FI, or other such transceiver (not shown). In addition, GPS (Global Positioning system) receiver module 270A may provide additional navigation- and location-related wireless data to device 250A, which may be used as appropriate by applications running on device 250.

Device 250A may also communicate audibly using audio codec 260, which may receive spoken information from a user and convert it to usable digital information. Audio codec 260A may likewise generate audible sound for a user, such as through a speaker, e.g., in a handset of device 250A. Such sound may include sound from voice telephone calls, may include recorded sound (e.g., voice messages, music files, etc.) and may also include sound generated by applications operating on device 250A.

The computing device 250A may be implemented in a number of different forms, as shown in the figure. For example, it may be implemented as a cellular telephone 280A. It may also be implemented as part of a smart phone 282A, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 200A and/or 250A) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 200A and 250A are configured to receive and/or retrieve electronic documents from various other computing devices connected to computing devices 200A and 250A through a communication network, and store these electronic documents within at least one of memory 204A, storage device 206A, and memory 264A. Computing devices 200A and 250A are further configured to manage and organize these electronic documents within at least one of memory 204A, storage device 206A, and memory 264A using the techniques described herein.

In addition, the logic flows depicted in the figures do not require the particular order shown, or sequential order, to achieve desirable results. Furthermore, other steps may be provided or steps may be eliminated from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. For example, while online gaming has been referred to throughout, other applications of the above embodiments include online or web-based applications or other cloud services.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

FIG. 2B illustrates an example embodiment of a mobile device 200B. This is but one possible device configuration, and as such it is contemplated that one of ordinary skill in the art may differently configure the mobile device. The device 200B may comprise any type of fixed or mobile communication device that can be configured in such a way so as to function as described below. The mobile device may comprise a PDA, cellular telephone, smart phone, tablet PC, wireless electronic pad, or any other computing device.

In this example embodiment, the mobile device 200B is configured with an outer housing 204B that protects and contains the components described below. Within the housing 204B is a processor 208B and a first and second bus 212B1, 212B2 (collectively 212B). The processor 208B communicates over the buses 212B with the other components of the mobile device 200B. The processor 208B may comprise any type of processor or controller capable of performing as described herein. The processor 208B may comprise a general purpose processor, ASIC, ARM, DSP, controller, or any other type processing device.

The processor 208B and other elements of the mobile device 200B receive power from a battery 220B or other power source. An electrical interface 224B provides one or more electrical ports to electrically interface with the mobile device 200B, such as with a second electronic device, computer, a medical device, or a power supply/charging device. The interface 224B may comprise any type of electrical interface or connector format.

One or more memories 210B are part of the mobile device 200B for storage of machine readable code for execution on the processor 208B, and for storage of data, such as image data, audio data, user data, medical data, location data, shock data, or any other type of data. The memory may store the messaging application (app). The memory may comprise RAM, ROM, flash memory, optical memory, or micro-drive memory. The machine readable code as described herein is non-transitory.

As part of this embodiment, the processor 208B connects to a user interface 216B. The user interface 216B may comprise any system or device configured to accept user input to control the mobile device. The user interface 216B may comprise one or more of the following: keyboard, roller ball, buttons, wheels, pointer key, touch pad, and touch screen. A touch screen controller 230B is also provided which interfaces through the bus 212B and connects to a display 228B.

The display comprises any type of display screen configured to display visual information to the user. The screen may comprise an LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 228B receives signals from the processor 208B and these signals are translated by the display into text and images as is understood in the art. The display 228B may further comprise a display processor (not shown) or controller that interfaces with the processor 208B. The touch screen controller 230B may comprise a module configured to receive signals from a touch screen which is overlaid on the display 228B. Messages may be entered on the touch screen 230B, or the user interface 216B may include a keyboard or other data entry device.

Also part of this exemplary mobile device is a speaker 234B and microphone 238B. The speaker 234B and microphone 238B may be controlled by the processor 208B and are configured to receive and convert audio signals to electrical signals, in the case of the microphone, based on processor control. Likewise, processor 208B may activate the speaker 234B to generate audio signals. These devices operate as is understood in the art and as such are not described in detail herein.

Also connected to one or more of the buses 212B is a first wireless transceiver 240B and a second wireless transceiver 244B, each of which connect to respective antenna 248B, 252B. The first and second transceiver 240B, 244B are configured to receive incoming signals from a remote transmitter and perform analog front end processing on the signals to generate analog baseband signals. The incoming signal may be further processed by conversion to a digital format, such as by an analog to digital converter, for subsequent processing by the processor 208B. Likewise, the first and second transceiver 240B, 244B are configured to receive outgoing signals from the processor 208B, or another component of the mobile device 208B, and up-convert these signals from baseband to RF frequency for transmission over the respective antenna 248B, 252B. Although shown with a first wireless transceiver 240B and a second wireless transceiver 244B, it is contemplated that the mobile device 200B may have only one such system or two or more transceivers. For example, some devices are tri-band or quad-band capable, or have Bluetooth and NFC communication capability.

It is contemplated that the mobile device, and hence the first wireless transceiver 240B and a second wireless transceiver 244B may be configured to operate according to any presently existing or future developed wireless standard including, but not limited to, Bluetooth, WI-FI such as IEEE 802.11 a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the mobile device is one or more systems connected to the second bus 212B which also interfaces with the processor 208B. These devices include a global positioning system (GPS) module 260B with associated antenna 262B. The GPS module to 260B is capable of receiving and processing signals from satellites or other transponders to generate location data regarding the location, direction of travel, and speed of the GPS module 260B. GPS is generally understood in the art and hence not described in detail herein.

A gyro 264B connects to the bus 212B to generate and provide orientation data regarding the orientation of the mobile device 204B. A compass 268B, such as a magnetometer, provides directional information to the mobile device 204B. A shock detector 272B, which may include an accelerometer, connects to the bus 212B to provide information or data regarding shocks or forces experienced by the mobile device. In one configuration, the shock detector 272B generates and provides data to the processor 208B when the mobile device experiences a shock or force greater than a predetermined threshold. This may indicate a fall or accident.

One or more cameras (still, video, or both) 276B are provided to capture image data for storage in the memory 210B and/or for possible transmission over a wireless or wired link or for viewing at a later time. The processor 208B may process image data to perform image recognition, such as in the case of, facial detection, item detection, facial recognition, item recognition, or bar/box code reading.

A flasher and/or flashlight 280B are provided and are processor controllable. The flasher or flashlight 280B may serve as a strobe or traditional flashlight, and may include an LED. A power management module 284 interfaces with or monitors the battery 220B to manage power consumption, control battery charging, and provide supply voltages to the various devices which may require different power requirements.

The gaming machine may be located at a casino (and as such is referred to as a “casino gaming machine”). The gaming machine may be part of a gaming system, such as a casino gaming system which links multiple of the gaming machines, one or more table games and other devices such as kiosks, accounting systems or servers, progressive systems or servers, player tracking systems or servers or the like. The wagering game Baccarat, or a variation thereof, such as EZ Baccarat may be presented to the player on the gaming machine.

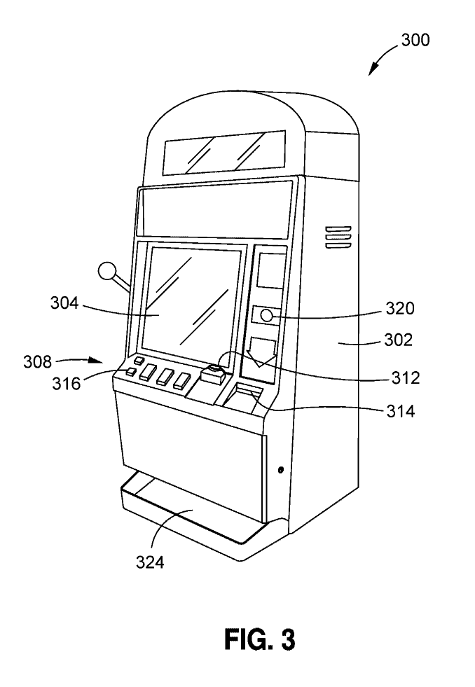

One configuration of a gaming machine 300 is illustrated in FIG. 3. As illustrated, the gaming machine 300 generally comprises a housing or cabinet 302 for supporting and/or enclosing various components required for operation of the gaming machine. In the embodiment illustrated, the housing 302 includes a door located at a front thereof, the door capable of being moved between an open position which allows access to the interior, and a closed position in which access to the interior is generally prevented. The configuration of the gaming machine 300 may vary. In the embodiment illustrated, the gaming machine 300 has an “upright” configuration. However, the gaming machine 300 could have other configurations, shapes or dimensions (such as being of a “slant”-type, “bar-top” or other configuration as is well known to those of skill in the art).

The gaming machine 300 preferably includes at least one display device 304 configured to display game information. The display device 304 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 304 may be capable of projecting or displaying a wide variety of information, including images, symbols and other indicia or information associated with game play, game promotion or other events.

As described in more detail below, the gaming machine 300 is preferably configured to present one or more games upon a player making a monetary payment or wager. In this regard, as described in more detail below, the gaming machine 300 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 300 includes means for returning unused monetary funds and/or dispensing winnings to a player.

The gaming machine 300 preferably includes one or more player input devices 308 (such as input buttons, plunger mechanisms, a touch-screen display, joystick, touch-pad or the like). These one or more devices may be utilized by the player to facilitate game play, such as by providing input or instruction to the gaming machine 300. For example, such input devices 308 may be utilized by a player to place a wager or a side wager, cause the gaming machine 300 to initiate a game, to indicate cards to be held or discarded, to “cash out” of the gaming machine, or to provide various other inputs.

In one preferred embodiment, the gaming machine 300 includes at least one microprocessor or controller for controlling the gaming machine, including receiving player input and sending output signals for controlling the various components of the machine 300 (such as generating game information for display by the display 304). The controller may be arranged to receive information regarding funds provided by a player to the gaming machine, receive input such as a purchase/bet signal when a purchase/bet button 316 is depressed, and receive other inputs from a player. The controller may be arranged to generate information regarding a game, such as generating game information for display by the at least one display 304 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 300 may also include one or more random number generators for generating random numbers, such as for use in selecting cards and for presenting the game in a random fashion.

Preferably, the controller is configured to execute machine readable code or instructions which are configured to implement the method of game play of the invention. For example, the controller of the gaming machine 300 may be configured to detect a wager, such as a signal from a player's depressing of the “bet one” button. Upon such an event and/or the player otherwise signaling the gaming machine to present the game, the controller may be configured to cause cards to be dealt/displayed on the at least one display 304. The controller may accept input from a player of a request to split, buy insurance, obtain additional cards, or the like via the one or more player input devices 308 of the gaming machine 300.

The gaming machine 300 may be configured to generate and present games in a stand-alone manner or it may be in communication with one or more external devices at one or more times. For example, the gaming machine 300 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 300 is configured to present one or more wagering games. Thus, the gaming machine 300 is preferably configured to accept value, such as in the form of coins, tokens, paper currency or other elements or devices representing value such as monetary funds. For example, as illustrated in FIG. 3, the gaming machine 300 might include a coin acceptor 312 for accepting coins. Of course, associated coin reading/verifying devices and coin storage devices may be associated with the gaming machine 300 if it is configured to accept coins. Likewise, the gaming machine 300 might include a media reader 314. Such a reader may be configured to accept and read/verify paper currency and/or other media such as tickets. Of course, in such event the gaming machine 300 may further be configured with one or more paper currency or ticket storage devices, such as cash boxes, and other paper currency or media handling devices (including transport devices).

The gaming machine 300 might also be configured to read FOBs, magnetic stripe cards or other media having data associated therewith and via which value or funds may be associated with the gaming machine 300.

In one embodiment, the gaming machine 300 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 300 dispensing coins to a coin tray 324. In another embodiment, funds may be issued by dispensing paper currency. In yet another embodiment, a player may be issued a media, such as a printed ticket, which ticket represents the value which was paid or cashed out of the machine.

The gaming machine 300 may also include a player tracking device, such as a card reader and associated keypad 320. Such player tracking devices are well known and may permit the game operator to track play of players of the gaming machine. The tracked play may be utilized to offer player bonuses or awards.

It will be appreciated that the gaming machine illustrated in FIG. 3 is only exemplary of one embodiment of a gaming machine. For example, it is possible for the gaming machine to have various other configurations, including different shapes and styles and having different components than as just described.

For example, it is possible for the base game and side wager to be presented on a computing device, including at a home or office computer, a kiosk or other types of devices. For example, the game and side wager might be presented via an application running on a computing device, or in a server-based or “Internet” environment. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

A casino may have numerous such gaming machines 300, such as located on a casino floor or in other locations. Of course, such gaming machines 300 might be used in other environments, such as an airport, a bar or tavern or other locations.

The side wager may also be presented one or more gaming devices 300 as described above while being simultaneously presented to players at gaming tables 151. The display 304 of the gaming device may show the amount of the progressive jackpot similar to the progressive display 196.

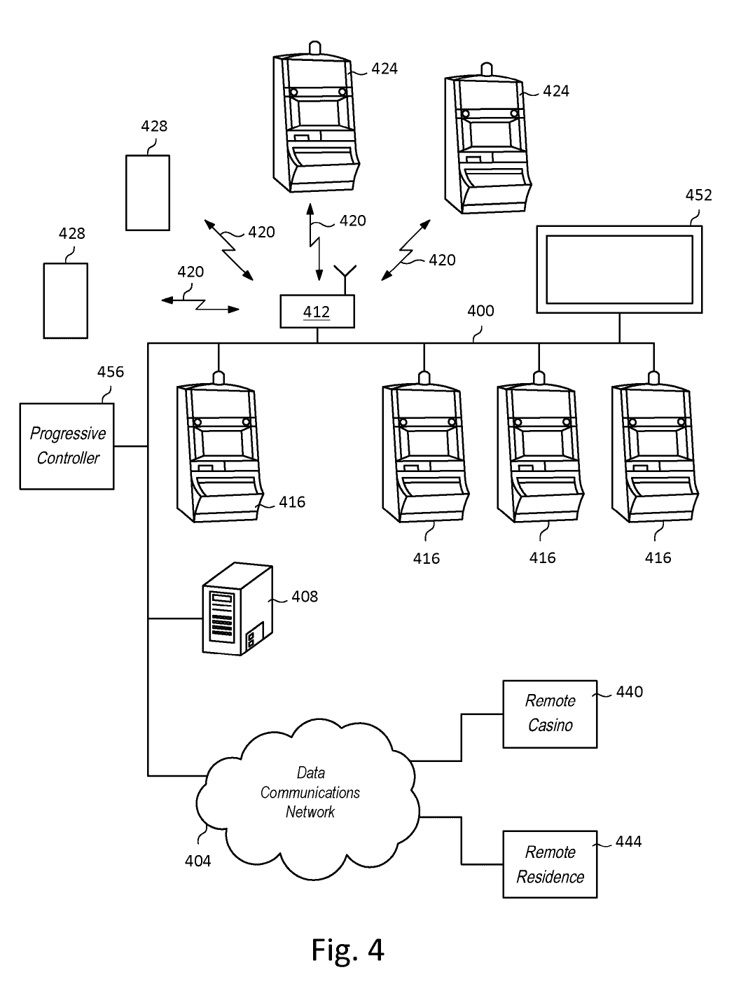

FIG. 4 is a block diagram of an example gaming system with a server based network. The communications network 400, 404 connects to multiple devices as discussed below to enable communication between devices. The network 400, 404 may be any type network capable of exchanging data between devices. The network may include a local network 400 and an external network 404 such as for example the Internet, or an Intranet with appropriate security mechanisms. The wagering game network may include other network devices, such as one or more servers which may comprise accounting servers, wide area progressive servers, player tracking servers, game content servers, or any other type server.

In this embodiment the gaming establishment at the top of the figure includes a network 400. As shown, the gaming network includes gaming machines 416 connected to the network 400 via a wired connection.

The network 400 may include a wireless device 412 capable of communicating over a wireless link 420 with one or more wireless gaming machines 424 or hand held gaming devices 428. A wagering game server 408 may serve wagering games on the gaming machines over the local area network 400 and function as a remote controller for the wagering games as described above.

The wagering network includes hardware and memory storing machine readable instructions and machine readable code for performing the operations described herein. Those of ordinary skill in the art will appreciate that each gaming establishment may include additional local area networks such which may serve to connect many other wagering games. Alternatively, multiple servers 408 may be used for the functions of the wagering game server which provide game content to the gaming machines 416, 424, 428.

The local area network 406 may be any type of suitable property LAN configuration including, for example, a dedicated hardwired property LAN or a wireless property LAN. The local area network 406 may be configured in any configuration or topology.

The local area network includes wired communication links 400 and wireless communication links 420. In this example configuration, the stand-alone gaming machines 416 communicate with the network 402, 408 via the wired communication links as shown. The stand-alone gaming machines 428 as well as the handheld gaming devices 428 communicate with the network 400, 408 via the wireless communication links 420. One or more wireless communication devices 412, with associated antennas, enables wireless communication. Other combinations of wired and wireless connections to different gaming machines may be used. The wired and wireless communication links may employ any suitable connection protocols such as Bluetooth, IEEE 802.11, Ethernet, or any other format or standard. The network 400, 408 may be configured to enable downloading of instruction sets (software) for games, game configuration data, game outcomes, from the central server(s) such as the server 408 to the gaming machines, and to enable uploading or downloading of marketing and operations data from the gaming terminals to the central server.

As shown at the bottom of FIG. 4, the game server 408 or network 400 may also serve wagering game devices and/or distribute content to devices located in other gaming establishment 440 or at other locations 444 such as a residence.

The server 408 may be any type computer capable of executing programs or instruction sets for controlling gaming machine, such as slot machines, video slots, or video poker machines, and communication with wireless devices. Although shown as a single server, numerous servers may be used. In such embodiments, the gaming machines 416, 424, 428 may each be a simple input/output terminal with regard to the functions controlled by the server 408. For example, the random selection of outcomes for the basic game and any bonus game may be functions performed by the server 408 and subsequently provided to a gaming machine. Functions that are not provided by the server 408, such as control of the local lights, sounds, and displays of the gaming machine, are handled by the local CPU within the gaming machine.

In this embodiment, a progressive or accumulated jackpot system is provided that includes a video or other type display 452 that is coupled to the network 400, 408. The display 452 is viewable by a number of players to present a total jackpot that is available for award upon receipt of a predetermined outcome. This type of event may be referred to as community based events accessible from games on the gaming machines or from remote locations 440, 444 or gaming devices 428. For example, the display 452 may be used to show a current progressive jackpot or jackpots which players playing different gaming machines may be eligible to win. The display 452 may be any type display.

In one embodiment, the community event is a progressive award or jackpot, which is preferably linked with other gaming machines via the network 400, 408 and/or the network 204. The entire progressive award or jackpot may be won upon the occurrence of a certain outcome of the game. In other embodiment, the award is not fixed but instead the size of the award or jackpot is random such that when an award is triggered an RNG or other mechanism generates a random value which determines the amount, size, or type of prize. The prize or award may be monetary or a tangible item or service.

The server 408 may also operate one or more progressive awards concurrently with the basic game and/or bonus games. As explained above, such progressive awards are funded by appropriating a percentage of the coin-in from participating gaming machines. To be eligible to win the progressive award, the player may be required to make a progressive award side wager or make a wager satisfying predetermined criteria. Then, upon occurrence of jackpot-won event in the form of either a “mystery” event or one or more predetermined outcomes in the basic game and/or bonus game, the player is awarded the progressive jackpot in addition to any regular prize or award resulting from the basic game and/or bonus game. A basic game menu may be part of the game disclosed herein and include several options for a player, including picking games, progressive options, and side bet options. Other community events may include a community bonus game, a bonus prize shared by multiple players, a multiplier award or other community features. Such a community event may interrupt the game play on the gaming machine and use other mechanisms such as the display 452 to show graphics or video relating to the community event. In this example embodiment, each one of the players who are currently playing wagering games on the gaming machines participates in the community event according to an eligibility criteria, such as time-based eligibility that each gaming machine determines locally. In this example, a community event or progressive controller 456 associated with the display 452 and progressive system continuously runs a process to determine if the community bonus should occur, using its random number generator (RNG) and monitor coin-in or wagers to increment the amount on the display. For example, controller 456 determines if the community event is triggered. If the controller 465 determines that the community event is triggered or won, then it will issue an invitation to the gaming machines. Because each of the wagering games on the gaming machines keeps track of the current eligibility of the respective games being played, each of the gaming machines makes a decision whether it will allow the player to participate in the community event, and at which multiplier any bonuses or prizes resulting from the community event will be awarded to the player. It is to be understood that a server such as the server 408 or a master gaming machine may be used for the controller 456.

The server 408 includes a storage device that contains software instruction sets for different wagering games which may be loaded onto a memory of gaming machines. It is to be understood that different parts of the instruction sets may be stored on the memory with other parts of the instruction sets stored on the individual gaming machines. For example, the gaming machines may store part of the instruction sets in the form of modules relating to graphics files, audio/sound files, and certain game functions and operations such as player greetings or instructions. The stored instructions sets are mated with the remainder of the instruction sets loaded from the memory over the network 400.

Part or all of the software instruction set for wagering games may be sent to the various gaming machines via the wired communication links 400 or the wireless communication links 420. The wagering games may be stand alone or may offer eligibility or access to progressive awards or support other community events with other gaming machines on the network 400 or external networks 404.

The server 408 in this example stores a number of wagering games in the storage device. It is to be understood that part of the software to support the wagering games may already reside on the system memory of the gaming machine. For example, the modules responsible for RNG, audio and/or video drivers, etc. may reside on the system memory of the gaming machine. Other components of the instruction set of the game such as graphics files, audio files etc. may also reside in the storage device. Some or all of the instruction set may be loaded via the external I/O circuit from the network 400 such as from the storage device of the server 408. In this manner, the gaming machine may be used to play different games without requiring manual delivery of instruction sets different games to the gaming machine.

For example, a player may request a certain wagering game based on an initial display of a menu of wagering games displayed by the gaming machine. The menu may include some or all available wagering games stored on the server 408. Other background graphics and/or videos may be displayed on the primary display or the secondary display of the gaming machine to attract players to the gaming machine. The secondary display may be electronic or a secondary game to present a secondary game outcome. Based on the menu display 400, a player may select the desired game via a player input device such as the push buttons or touch screen buttons. Further, an operator of the casino may use the server to load wagering games to different gaming machines based on popularity, location, time interval, special events, schedule, etc.

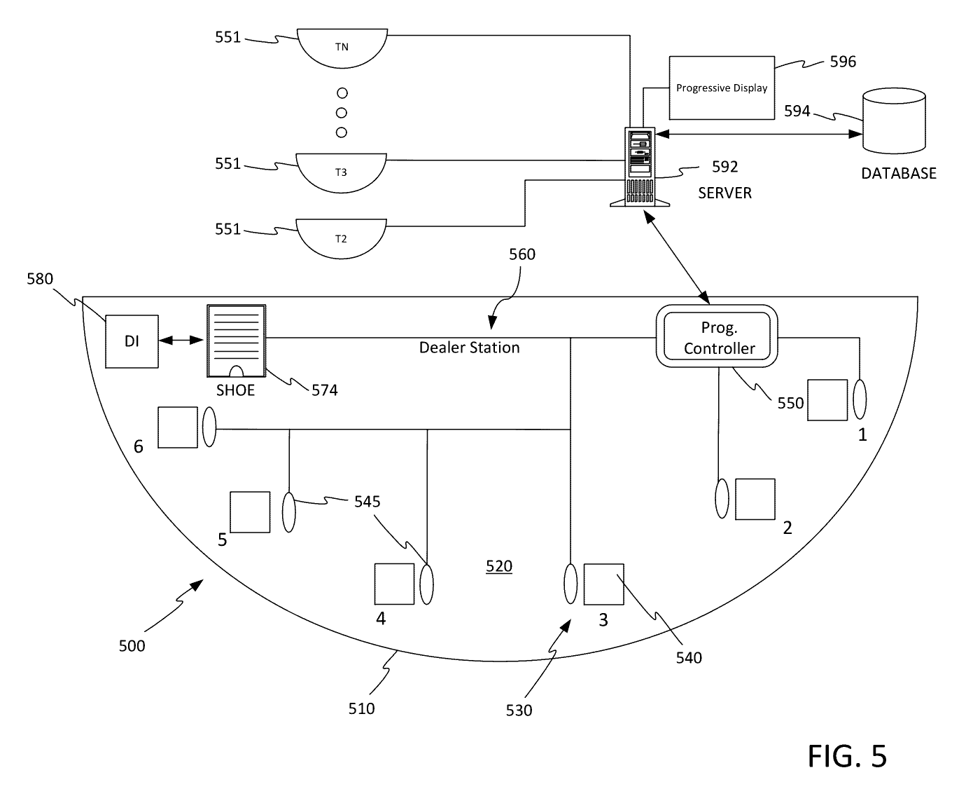

FIG. 5 illustrates a block diagram of an example embodiment of a gaming table 500. This is but one possible table arrangement and layout and it is contemplated that one of ordinary skill in the art may arrive at other table arrangements to promote game play or accommodate a greater or fewer number of players. For example, it is contemplated that the method and apparatus described herein may be utilized with any game layout. Likewise, the table can be configured in a stand-up or sit down arrangement.

In this example embodiment, gaming table 500 includes an outer edge 510 surrounding a generally flat top surface 520. The table 500 may also be configured to accommodate other types of traditional table games including, but not limited to, any type of blackjack, poker wherein the house only receives a percentage or rake from the pot of money wagered by the players, baccarat, pai gow, proprietary table games, or non-proprietary card table games which may use any combination of dice, wheels, or cards. Traditional table games include games of chance that use cards or dice, and tokens (also denoted as gaming chips), currency, currency equivalents or credit vouchers which may be of differing values. Of course, any table game may be played in a tournament format. In this discussion, the table is configured for use as a blackjack table.

Traditional table games also include proprietary games. Proprietary table games are table games for which a casino will lease or purchase from a manufacturer because the proprietary traditional table game is protected by the intellectual property of the manufacturer. The following description illustrates an exemplary embodiment of the system with reference to playing a blackjack card game. Of course, without limiting the scope of the disclosure, the forms, types, and variations of the game are immaterial to the teachings of the present invention.

As is well known by a person skilled in the art, in a round of playing a blackjack card game, initially a hand comprising two cards may be dealt by a dealer to one or more players and to the dealer. The dealer may distribute cards to the players face-up from one or more decks of cards according to pre-established rules of the game. In other variations of the game, the dealer may deal cards face-down to the players. The dealer is dealt one card face-up and one card face-down (termed the hole card). During play of the game, each player may receive further cards (termed being hit) from the dealer to improve the player's hand. The dealer may discard (or according to the terminology of the art “burn”) one or more cards when dealing the cards to insure security of the game. Additionally, the dealer may discard a hand when a player folds the hand. When all players stand (in other words, cease requesting cards), playing card distribution to the one or more players ceases and the dealer may reveal the dealer's hand. The dealer may further deal cards to the dealer's hand. When no further cards are distributed to the dealer (known in the art as the dealer stands) the players' hands may be compared to the dealer's hand and a settlement may occur between the dealer and each player. The dealer may then dispose of all cards, and begin yet another round of play of the game.

In this example embodiment of a gaming table 500, there is an outer edge 510 of the table. One or more player stations 530 (also denoted herein as player locations) are provided and configured for use by a player to participate in a wagering game or a game of chance offered at the table 500 such as blackjack. In this embodiment the player stations 530 comprise a player position 540 wherein a player is dealt playing cards and a player may accumulate tokens during the course of play. For example, the player may place original gaming chips (or tokens) and tokens that are won within the area of player position 540 during the course of play.

In other embodiments, one or more progressive wager detectors 545 may be located in one or more other locations on the table surface 520 or be a separate device independent from the table 500. The progressive side wager detectors 545 may comprise a coin-in (or token) slot which accepts a coin or token or an RFID or optical detector which detects the side wager or progressive wager. By way of example, a wager detector 545 may be associated with each player position 540 or may be shared by more than one player. In operation, when a player makes a wager, a player takes tokens from the player's token zone and places them in or on the wager detector 545.

In another embodiment a portable Personal Bet Manager may be provided whereby a player may purchase credits which are registered or stored on the Personal Bet Manager. The Personal Bet Manager includes a user interface whereby the player may then bet the credits that are registered or stored on the Personal Bet Manager, which is available from DEQ Systems Corp. located in Quebec, Canada. The Personal Bet Manager may communicate wirelessly, or via a wired connection, with other components to indicate a player's progressive wager. It is contemplated that the wager detector may be the Personal Bet Manager system.

Additionally, the table 500 may comprise supplement bet spots, token buy-in spots and the like. Optionally, in another embodiment of the table 500, the table's player positions 540 may be configured as card spots and associated card detection zones (not shown). Playing cards may be configured with elements detectable by the card detection zones. Such detection may be by various means including, but not limited to optical and UV scanning and radio wave scanning (better known as radio frequency identification or RFID).

The table may also comprise an optional electronic card reading shoe 574 configured to read the suit and rank of dealt cards. The shoe 574 may communicate with other elements of the table and progressive system. The shoe 574 may also perform card shuffling and present the cards for dealing. A dealer interface 580 is provided and may be connected to the shoe 574 to provide dealer control and to interface with the shoe, such as by providing information regarding cards dealt to the dealer.

The wager detectors 545, and optionally the shoe 574 electrically communicate with a progressive controller 550 that is associated with the table 500. The progressive controller 550 may be disposed, for example, under the table 500, or at a remote location. The shoe 574 or bet detection areas 545 may communicate to the progressive controller 550 to indicate to the progressive controller 550 when a player qualifies for, based on dealt cards, a progressive jackpot or award, and optionally the payout amount based on the cards dealt to the player. This information may be used by the dealer to assist in game play and track progressive participation. The progressive controller 550 records which player positions have placed a progressive wager to allow that player to participate in the progressive. The progressive controller 550 may also time stamp the time of the wager paid by a player or the dealing of cards to a player from the electronic shoe to establish a timing event for the player in relation the wager and secondary game. The controller 550 may also calculate the amount wagered for progressive participation for each table and communicate that to the server 592. Additional tables 555 may also be similarly configured and linked to either the controller 550 or server 592 as shown.

The progressive controller 550 is in communication (wired or wirelessly) with one or more servers 592. The servers 592 may be configured as is known in the art with a processor configured to execute non-transitory machine readable code (software) which is stored in one or more memories. There may be one or more other tables 551, numbered T2 thought TN, where N is any whole number in addition to the table 500. A progressive display 596 also connects to the server 592. The server 592, executing machine readable code, is configured to sum the progressive wagers and display the total possible amount to be won on the progressive display 596. By displaying the large potential progressive payout on the display 596, players are encouraged to play the base game and the progressive. One or more databases 594 are optionally provided to store data, machine readable code, or a combination thereof.

A player may receive cards from a dealer and place them on a player's card position 540. Each player's cards may be detected and monitored by the dealer in an associated card detection zone and the table may be equipped with RFID, overhead, dealer or player active detectors, or other card or token readers. The player positions 540 may also detect or provide space for wagers, such as progressive bets, that are placed and detected with the bet detectors 545. Without limiting the disclosure, it will be appreciated that the table 500 may comprise any number of or combination of player positions 540, detection spots and associated detection zones (bet detectors 545), and the like as discussed above to achieve operation as described herein.

In one example embodiment, the table 500 may comprise a dealer station 560 for a dealer. As is generally understood, the dealer may present the game from the dealer station 560 by dealing cards to players. The dealer station 560 is a location on or in some way associated with the table 500 and/or the dealer on which tokens or playing cards may be placed.

The dealer interface 580 (referred to as DI in FIG. 5) may also be placed near the dealer station 560. The dealer interface 580 comprises a user interface configured to allow the dealer to provide input to the shoe 574 and optionally receive output from the shoe, which can be presented to the dealer and the server 592. In various embodiments, the dealer interface 580 comprises one or more buttons, dials, display screens, LCD/touch screen, lights or other illumination devices, speakers or other audible indicators, or analog dials, potentiometers, or keypads. Through use of the dealer interface 580, the dealer is able to provide input to the shoe 574 or receive data from the shoe 574.

In yet another embodiment, the dealer interface 580 may be configured to communicate with a detection system (discussed above), a player tracking system (as monitored and controlled such as by one or more servers 592) and an accounting system.

In FIG. 1 the one or more components may all be integrated into a single device. For example, the dealer interface 580 may be part of the shoe/shuffler 574. In addition, the table may also include a player tracking device, such as a card reader and associated keypad. Such player tracking devices are well known and may permit the game operator to track play of players at the gaming table. The tracked play may be utilized to offer player bonuses or awards.

Servers 592 may additionally have other functions, such as tracking players to provide coupons (also termed “comps”) based on various aspects of players' behaviors. Without limiting the scope of the disclosure, behaviors that may trigger an award of player comps and subsequent printing of player coupons include amounts wagered, won, or lost, number of hands played by the player, or random events, such as a mystery award. Input from a player tracking system may also be utilized. Furthermore, servers 592 may provide accounting and auditing functions during play of a game.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method of playing a game at a gaming machine comprising the machine-implemented steps of:
providing a gaming machine, gaming machine including a housing, a gaming machine display, a player interface, a bill or ticket acceptor, a memory storing non-transitory machine-readable code, and a processor configured to execute the machine readable code to perform one or more of the following steps of the method:
displaying on the gaming machine display one or more side areas which provide other player's wager information in or on the side areas;
receiving a player wager with a bill or ticket acceptor that is part of the gaming machine, the player wager having an amount and placed on at least one of a player hand wager, a banker hand wager, and a tie wager;
dealing and displaying playing cards to a player on the gaming machine display to create a player card set and a banker card set;
calculating a player hand rank and a banker hand rank;
evaluating the player hand rank and a banker hand rank to determine a game outcome, the game outcome being a player hand higher than banker hand, banker hand higher than player hand, or a tie; and
providing an award to the player if the player wager matches the game outcome.

2. The method of claim 1 updating the one or more side areas with the game outcome, which of the other player had winning wagers, or both.

3. The method of claim 1 wherein the one or more side areas further display wager amounts by other players.

4. The method of claim 1 wherein the controller is a processor configured to execute the machine readable code.

5. The method of claim 1 wherein the one or more side areas further display a player name and wager amount.

6. The method of claim 1 wherein the one or more side areas further display game outcomes for one or more prior games.

7. The method of claim 1 wherein the side areas are configurable by a player to display one or more of the following: amount wagered, specific player wager amounts, specific player bet history, past game outcomes.

8. A gaming machine comprising:
a controller;
at least one electronic display;
at least one player input device on the gaming machine;
a monetary acceptor configured to receive a ticket or monetary value from a player to establish credits on the gaming machine, the credits wagerable via the player input device;
a ticket-in and ticket-out device configured to accept and print tickets, the ticket representing monetary value which may be redeemed for credits at the gaming machine;
a memory storing machine-readable code, the machine-readable code executable by the controller to present a base game at the gaming machine the base game including the following steps:
receiving a player wager using credits, the credits establish on the gaming machine by a player using the monetary acceptor or the ticket-in and ticket-out device, the player wager having an amount and placed on at least one of a player hand wager, a banker hand wager, and a tie wager;
displaying, in one or more side areas of the electronic display, other player's wager information;
dealing and displaying playing cards to a player on the gaming machine display to create a player card set and a banker card set;
calculating a player hand rank and a banker hand rank;
evaluating the player hand rank and a banker hand rank to determine a game outcome, the game outcome being a player hand higher than banker hand, banker hand higher than player hand, or a tie; and
providing an award to the player if the player wager matches the game outcome.

9. The gaming machine of claim 8 wherein the one or more side areas further display wager amounts by other players.

10. The gaming machine of claim 8 wherein the controller is a processor configured to execute the machine readable code.

11. The gaming machine of claim 8 wherein the one or more side areas further display a player name and wager amount.

12. The gaming machine of claim 8 wherein the one or more side areas further display game outcomes for one or more prior games.

13. The gaming machine of claim 8 further comprising a computer network configured to transmit and receive game and wager information to other gaming machines.

14. The gaming machine of claim 8 wherein the side areas are configurable by a player to display one or more of the following: amount wagered, specific player wager amounts, specific player bet history, past game outcomes.
